(19) United States
(12) Patent Application Publication
(10) Pub. No.: US 2006/0088350 A1
(43) Pub. Date: Apr. 27, 2006

(54) Fixing device in image forming apparatus with pressing roller having a reversed crown shape

(75) Inventor: Koji Imamiya, Kanagawa-ken (JP)

Correspondence Address: FOLEY AND LARDNER LLP;SUITE 500, 3000 K STREET NW, WASHINGTON, DC, 20007, US

(73) Assignees: KABUSHIKI KAISHA TOSHIBA; TOSHIBA TEC KABUSHIKI KAISHA

(21) Appl. No.: 10/972,677

(22) Filed: Oct. 26, 2004

(51) Int. Cl. G03G 15/20

(52) U.S. Cl. 399/333

(57) ABSTRACT

In a fixing device of an image forming apparatus of the present invention using toners that are erasable after fixed, a pressing roller in contact with a fixing roller of the fixing device is formed in the reversed crown shape and a sheet of paper is surely pulled to both edge portions from the central portion of the paper in the nip formed between the fixing roller and the pressing roller. Irrespective of use of the fixing device for an extended period of time, a fixed image of high quality without paper wrinkles can be obtained.

### BACKGROUND OF THE INVENTION

1. Field of the Invention

The present invention relates to a fixing device that is used in such an image forming apparatus as a copying machine, a printer, a facsimile, etc. capable of forming and decolorizing a toner image repetitively for fixing a toner image on a paper.

2. Description of the Related Art

As a fixing device that is used in an image forming apparatus as electro-photographic copier, printer, etc., there is a device to fix a toner image on a sheet of paper by inserting a paper in the nip formed between a roller pairs comprising a fixing roller and a pressing roller or a similar belt pair by heating and pressing a toner image. To prevent paper from wrinkled in such a heat pressing type fixing device when sheets of paper are inserted into the nip formed between the fixing roller and the pressing roller, a device of which fixing roller and pressing roller are formed in a reversed crown shape is disclosed in the Japanese Patent No. 3072781.

On the other hand, with the progress of the office automation, the output of information printed on paper is increasing in recent years accompanied with the increase in volume of various information and a large amount of paper is consumed. As this consumption of a large quantity of paper may lead to the destruction of nature for securing resource of paper, and the paper recycling is so far made.

This paper recycling is conducted by processing used paper printed with toner image information using a large quantity of bleaching agent and water and recycled paper are manufactured. However, such the paper recycling results in increase in cost of recycled paper, and the economical efficiency of the process is impaired and also a new environmental pollution resulting from the process of waste water used in the recycling of used paper may be generated.

In recent years, therefore, instead of paper recycling of used paper itself, the practical reuse of used paper by erasing image data formed on used sheets of paper repetitively for the new output of image information is planned. For the reuse, the image forming and erasing are conduced using, for example, a toner that is erasable when the connection with a coupler is cut by heating and the same sheet is used repeatedly.

When the paper quality is lowered remarkably by the repetitive use, the paper can be recycled and paper resource can be further used effectively and the environmental conservation can be assured and paper cost also can be reduced. In the environmental conservation, for example, CO₂ emissions were estimated according to the life cycle assessment (LCA), it was reported that about 50% of CO₂ can be reduced when paper is reused for 4 times.

However, in the paper reuse described above, for example, sheets of paper are heated for above 2 hours at 120 to 150° C. and then cooled for erasing toner images. On the other hand, in an image forming apparatus utilizing the conventional electro-photographing, the image forming again on paper by heating at 120 to 150° C. and cooling described above was not assumed and therefore, there were problems shown below. That is, it was revealed that when the image was formed on a reused paper using a conventional image forming apparatus, there was no problem at the initial stage but when the image was formed repeatedly, wrinkles were caused on paper when paper are passing through a fixing device.

This is considered because the moisture absorbing state of paper became uneven when the paper were left at room temperature and moisture after they were once dried by heating to erase toner images for reusing and made loose lightly. In other words, the moisture absorbing rate of use paper is not restored to the even state of new paper and partially uneven moisture absorbing rate is considered one of causes for generating wrinkles on paper by a fixing device. (Described in Paragraph (5) Moisture, Base and Application of Electro-Photographic Technology Society 1988, P513).

Further, the proper load distribution in the nip between the fixing roller and the pressing roller became no longer obtainable for deterioration of the elastic body of the pressing distribution in the nip between the fixing roller and the pressing roller. This can be another cause for generating paper wrinkles. When the surface of the elastic body of the pressing roller is deteriorated, a force to pull a paper to the edge portion from the central portion does not work effectively especially when a reuse paper is inserted between the fixing roller and the pressing roller and this is considered to generate wrinkles on paper.

So, a fixing device capable of preventing generation of paper wrinkles when passing a fixing device of an image forming apparatus and excellent in the economical efficiency as well as environmental conservation irrespective of use for an extended period of time when using reuse paper is desired.

### SUMMARY OF THE INVENTION

An object of the embodiment of the present invention is to obtain a fixed image of high quality without generating wrinkles on reuse paper that is excellent in the economical efficiency and environmental conservation using a fixing device to make the heating and pressing.

According to the embodiment of the present invention, there is provided a fixing device in an image forming apparatus to form an image on a recording medium using toner which can be decolorized after fixed, comprising a fixing rotary member in contact with a toner image forming surface of the recording medium; and a pressing rotary member having a reversed crown shape in pressing contact with the fixing rotary member to convey the recording medium in a specified direction.

### BRIEF DESCRIPTION OF THE DRAWINGS

FIG. 1 is a schematic construction diagram showing an image forming unit of an image forming apparatus in the embodiment of the present invention;

FIG. 2 is a schematic construction diagram showing an fixing device in the embodiment of the present invention;

FIG. 3 is an explanation diagram showing the constructions of the fixing roller and the pressing roller in the embodiment of the present invention; and

FIG. 4 is a table showing (Test Example) and (Comparison Example) in the fixing tests conducted in the embodiment of the present invention.

### DETAILED DESCRIPTION OF THE INVENTION

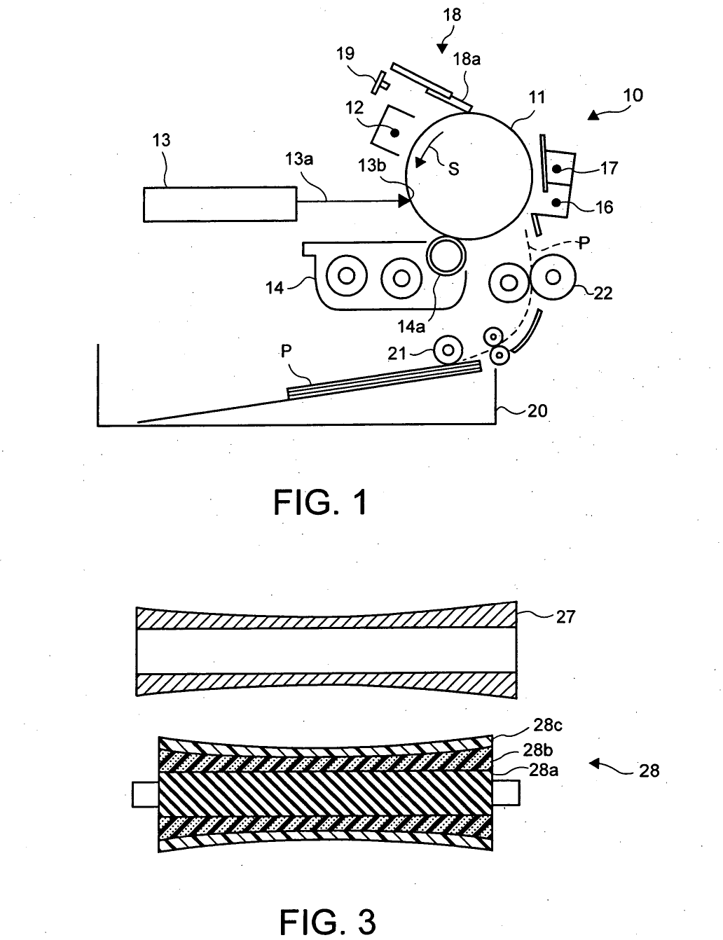

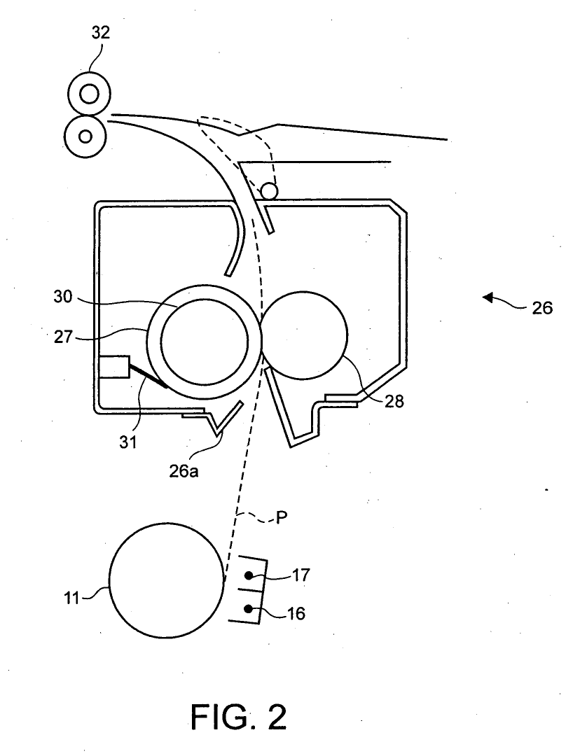

The embodiment of the present invention will be explained below in detail referring to the attached drawings. FIG. 1 is a schematic construction diagram showing an image forming unit 10 of a copying machine that is an image forming apparatus. FIG. 2 is a schematic construction diagram showing a fixing device 26 in the embodiment of the present invention. The image forming apparatus in this embodiment forms images using toners of which colors are erased by heating. Further, the image forming apparatus is capable of forming an image on a paper that is reused repetitively by erasing a toner image.

A photosensitive drum 11 of the image forming unit 10 has an organic photo conductor (OPC) on the surface of a φ 60 mm support member and is driven at a peripheral speed 215 mm/sec. Around the photosensitive drum 11, a main charger 12 to uniformly charge the photosensitive drum 11 to −750V following the rotation of the photosensitive drum 11, a laser beam irradiating position 13b of a laser beam 13a from a laser exposure device 13 which irradiates laser beams to the charged photosensitive drum 11 corresponding to image information, a developing unit 14, a transfer charger 16, a separation charger 17, a cleaner 18 equipped with a cleaning blade 18a and a charge eliminating LED 19 are arranged.

A paper P that is a recording medium is taken out of a paper supply cassette unit 20 by a paper supply roller 21 and conveyed to the position of the transfer charger 16 of the image forming unit 10 in synchronous with a toner image formed on the photosensitive drum 11. The paper supply cassette unit 20 is capable of supplying both of unused paper and reuse paper.

The developing device 14 uses two-component developer that is a mixture of toner in mean volume particle diameter 8 to 12 μm and magnetic carrier in mean volume particle size 60 to 80 μm. A toner is “Decolorisable Toner “e-blue” (Registered Trademark of Toshiba) (hereinafter, called as Decolorisable Toner)”. This toner is obtained by kneading binder resin, pigment, coupler, decolorizer, wax, etc. and ground, classified, and an additive added. The decolorisable toner cuts off the connection of toner coupler and color pigment by heating a toner image formed paper at 120 to 150° C. for 2 hours. About −550V developing bias is applied to the developing roller 14a of the developing unit 14 and a toner image is formed for an electrostatic latent image on the photosensitive drum 11 through the reverse development.

Above the image forming unit 10, a fixing device 26 is arranged to heat, press and fix a paper P, that is a recording medium, with an unfixed decolorisable toner image formed by the image forming unit 10. The fixing device 26 has a fixing roller 27 that is a fixing rotary member and a pressing roller 28 that is a press rotary member press contacting the fixing roller 27. Further, the fixing device 26 has an inlet guide 26a to lead a paper P into the nip formed between the fixing roller 27 and the pressing roller 28.

The fixing roller 27 is made of an iron hollow cylinder with PTFE (Polytetrafluoroethylene) coated on the surface. The fixing roller 27 has an IH coil (induction heating coil) 30 in its inside to induction heat the fixing roller 27 directly from the inside. Current applied to the IH coil 30 is controlled to a specified temperature by a control unit (not shown) according to the output of a thermistor 31 in contact with the surface of the fixing roller 27 to sense its temperature.

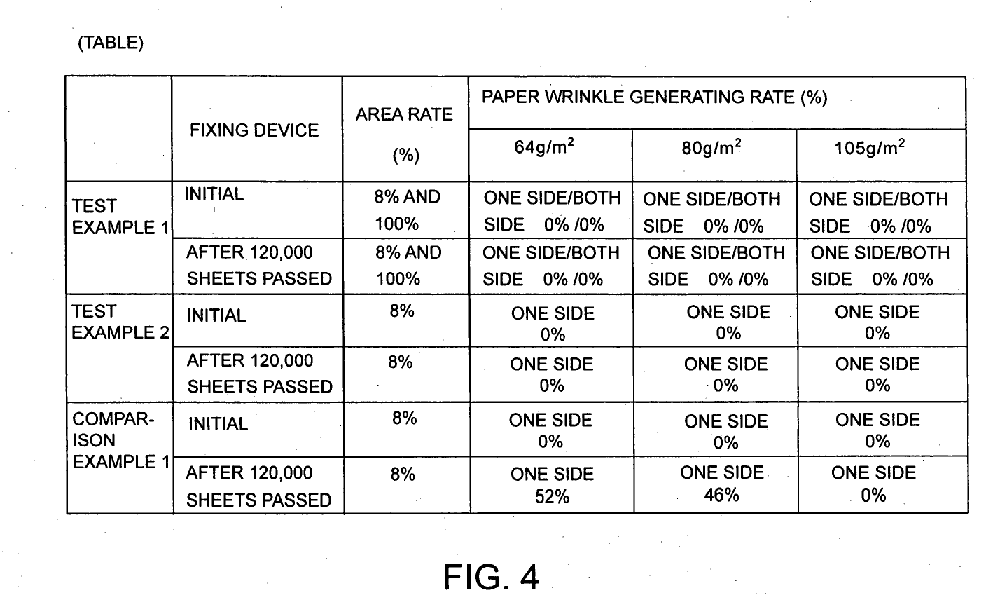

The pressing roller 28 is composed of a metal shaft 28a having an elastic body layer 28b of blowing silicon sponge rubber, etc. formed on the shaft 28a covered by a PFA (a copolymer of polytetrafluoroethylene and parfluoroalkylvynilether) tube 28c as shown in FIG. 3. The hardness of the pressing roller 28 is about 55° at ASKER-C. The pressing roller 28 is provided with a large nip by the elastic body layer 28b to make a low heat capacity for the energy saving fixing.

The fixing roller 27 and the pressing roller 28 are in the reversed crown shape wherein the diameter is gradually increasing from the central portion to the edge portion. The fixing roller 27 is about 380 mm long, the outer diameter D₀ at the reversed crown shaped central portion is 39.77 mm and the outer diameter D₁ at the edge portion is 39.92 mm. The reversed crown quantity ΔD₂ of the outer diameter D₀ at the central portion and the outer diameter D₁ at the edge portion is 150 μm. The edge portion referred to here is a position away 150 mm from the center and the effective using region is about 316 mm centering around the center.

The pressing roller 28 is about 320 mm long, the outer diameter D₃ of the central portion of the reversed crown shape is 29.8 mm and the outer diameter D₄ of the edge portion is 30.0 mm. The reversed crown quantity ΔD₅ of the pressing roller is 200 μm.

The edge portion referred to here is a position 150 mm away from the central portion and the effective using region is about 316 mm centering around the center. The nip between the fixing roller 27 and the pressing roller 28 applied with a load was about 5 mm at the central portion and about 6.5 mm at the edge portion at the initial time. Further, in the so-called life state after the paper supply test of 120,000 sheets, the nip between the fixing roller 27 and the pressing roller 28 was 6 mm at the central portion and about 7 mm at the edge portion. At the downstream in the conveying direction of paper P of the fixing device, a paper discharge roller 32 is provided to discharge paper P after fixing in the specified direction.

Next, the operation will be described. When the image forming process starts, in the image forming unit 10, the photosensitive drum 11 that rotates in the arrow direction s is uniformly charged to −750V by the main charger 12 and the laser beam corresponding to document information is irradiated by the laser exposing unit 13 and an electrostatic latent image is formed. Then, this electrostatic latent image is developed using color erasable toner by the developing device 14 and a toner image in color erasable toner is formed on the photosensitive drum 11.

On the other hand, for example, a specified paper P supplied from the paper supply cassette 20 is conveyed to the transfer charger 16 in sync with the forming of the toner image on the photosensitive drum 11 by the aligning roller 22 and the toner image on the photosensitive drum 11 is transferred on the paper P.

Then, the paper P is separated from the photosensitive drum 11 and thereafter, inserted between the fixing roller 27 and the pressing roller 28 of the fixing device 26, and the toner image is heated, pressed and fixed. Because the fixing roller 27 and the pressing roller 28 are in the reversed crown shape, the both edges of paper P are surely pulled in advance of the central portion when inserted into the nip between the fixing roller 27 and the pressing roller 28. For the reversed crown shape of the pressing roller 28, the paper P is heated, pressed and fixed while pulled in the edge direction from the central portion and generation of wrinkles is thus prevented. After the color erasable toner image is fixed by the fixing device, the paper P is discharged in the specified direction by the paper discharging roller 32. After completing the transfer, residual toner left on the photosensitive drum 11 is cleaned by the cleaner 18, the residual charge is eliminated by the charge eliminating LED 19 and the image forming process is completed.

After a color erasable toner image corresponding to an image information was formed, the toner image color is erased for reuse of paper. For erasing the toner image color, for example, using Toshiba exclusive decolorising apparatus “e-blue Decolorizer: TMD-HE01”, the toner image is decolorized by heating at 120 to 150° C. for about 2 hours in the decolorizer and then, automatically cooled for about 1 hour. When reuse toner image erased paper P, paper P should be lightly made loose to separate sheets of paper that are made slightly adhesive as a result of heating and supplied to the paper supply cassette 20. The reuse sheets of paper P supplied to the paper supply cassette 20 are supplied for the image forming according to the process described above.

As a result, on both unused sheets of paper and reuse paper, no wrinkle was caused on the paper and fixed images of high quality could be obtained.

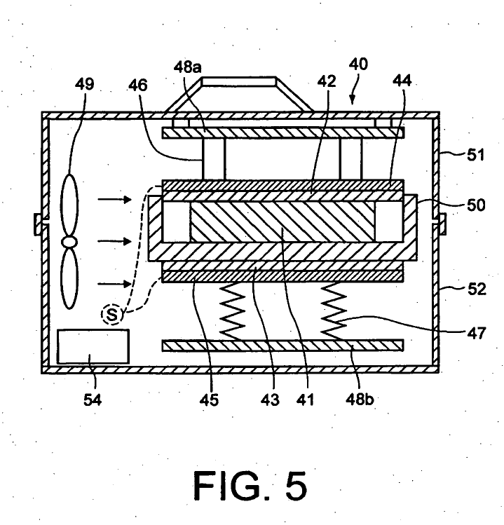

Then, in this embodiment, fixing tests were conducted using unused and reuse sheets of paper and as comparison examples, the fixing test was conducted by changing the pressing roller 28 to a straight shape pressing roller. The results of the tests will be described referring to the table shown in FIG. 4.

### TEST EXAMPLE 1

(1) Toshiba Tec made unused P-50S of weighting capacity 64 g/m², (2) NEUSIDLER made paper of weighing capacity 80 g/m² and (3) NEUSIEDLER made paper of weighing capacity 105 g/m² were used.

The paper feeding tests in the A4 size lateral direction for one side copying and both sides copying were conducted.

The tests were conducted at 2 levels of area rates 8% and 100%. The area rate is a black color percentage of a document; 8% means a character printed document and 100% means a solid black document.

As a result of the tests, in (Test Example 1), no paper wrinkle was recognized on one side and dual sides of sheets of paper (1) to (3) in the fixing tests conducted initially and after passing 120,000 sheets at the 8% and 100% area rates.

### TEST EXAMPLE 2

In this test, Toshiba Tec made P-50S reuse paper (1a) of weighing capacity 64 g/m², NEUSIEDLER made paper (2a) of weighing capacity 80 g/m², and NEUSIEDLER made paper (3a) of weighting capacity 105 g/m² were used. A document of 8% area rate was copied in 400 sheets and 200 sheets were bundled in a bundle and 2 bundles were set in Toshiba exclusive decolorising apparatus “e-blue Decolorizer: TMD-HE01” and heated at 120 to 150° C. for about 2 hours and after left for about 1 hour to cool down automatically, the paper was taken out and loosened lightly and used.

The paper feeding test in the A4 size width direction for one side copying.

The area rate was 8%.

As a result, in (Test Example 2), no paper wrinkle was recognized on (1a) to (3a) paper in the one side printing at the initial time and after feeding 120,000 sheets.

Further, after forming a toner image at the 8% area rate, the formed toner image was decolorised. This operation was repeated and using sheets of paper after the toner image was decolorised 9 times, the fixing test was conducted by the fixing device after feeding 120,000 sheets and no generation of paper wrinkle was recognized.

### COMPARISON EXAMPLE 1

An elastic body layer was formed on the metal shaft of the pressing roller contacting the fixing roller 27 and the surface was covered by a PFA tube. ASKER-C hardness of the pressing roller is about 55° in a straight shape in the length 320 mm and the outer diameter 30 mm. In (Comparison Example 1), the nip between the fixing roller 27 and the pressing roller was about 5.5 mm at the central portion, about 6 mm at the edge portion at the initial stage and in the so-called state after feeding 120,000 sheets, 6.5 mm at the central portion and about 7 mm at the edge portion.

With from of reuse paper (1a) to (3a) of the same condition as use by (Examination Example 2.

The paper feeding test for one side copying in the A4 size width direction was conducted.

The area rate was 8%.

As a result, in (Comparison Example 1), no paper wrinkle was recognized on (1a) to (3a) paper at the initial stage. However, after feeding 120,000 sheets, paper wrinkles were generated at a rate of 52% on reuse paper of a weighing capacity 64 g/m² (1a) and a rate of 46% on reuse paper of a weighing capacity 80 g/m² (2a).

One of the causes for generating paper wrinkles when a fixing device was used after feeding 120,000 sheets in (Comparison Example 1) is considered that a proper load distribution could no longer be obtained in the nip between the fixing roller 27 and the pressing roller because the elastic body layer of the pressing roller in the straight shape was deteriorated as affected by the paper feeding and the high temperature state for an extended period. Therefore, after sheets of paper heated by the exclusive toner erasing apparatus were once dried, the sheets were left in the room temperature and moisture environment and a toner image was once erased and then, when the toner image was formed again on the reuse sheets of which moisture absorbing rate was low and moisture was unevenly absorbed, a force of pulling sheets from the central portion to the edge portion in the nip did not act effectively.

On the contrary to this (Comparison Example 1), in (Test Example 2), irrespective of reuse sheets of paper of low moisture absorbing rate and unevenly adjusted moisture contents, the sheets are satisfactorily heated, pressed and fixed while pulled at both edges in the nip between the fixing roller 27 and the pressing roller 28 even after 120,000 sheets were fed because the pressing roller 28 of the fixing device 26 is in the reversed crown shape.

According to this embodiment, in the fixing device 26 of an image forming apparatus to form a toner image using a toner which can be decolorised when heated, the pressing roller 28 is formed in a reversed crown shape and by contacting the fixing roller 27, sheets of paper having a decolorisable toner image is heated, pressed and fixed. Therefore, in the life state after feeding 120,000 sheets, in the nip between the fixing roller 27 and the pressing roller 28, sheets can be surely pulled to both edges from the central portion and generation of paper wrinkles at the time of fixing can be prevented irrespective of reuse paper having low moisture absorbing rate and unevenly adjusted moisture.

Further, when the paper feeding test for one side and both side copying was conducted using unused paper instead of reuse paper in the comparison example 1, no paper wrinkle was generated on all sheets of paper at the initial time and after feeding 120,000 sheets.

Further, the present invention is not restricted to the above embodiments but can be modified variously within the scope of the invention. For example, the construction of an image forming apparatus which installs the fixing device of this invention is not limited and can be a color image forming apparatus and the fixing rotary member of the fixing device may be a fixing belt, etc. Further, the mechanism to decolorise is also not restricted and colors are optional provided that toners can be decolorised after fixed.

In addition, a heating temperature and a heating time when erasing colors by heating and furthermore, a cooling time are also not restricted.

Further, the quantity of reversed crown of the press rotating body is not restricted if it is within the range generating no paper wrinkle when fixing reuse paper in the life state of the fixing device. However, the fixing test was conducted by changing the reversed crown quantity ΔD₅ of the pressing roller in the above embodiment. When the reversed crown quantity ΔD₅ was 50 μm and Toshiba Tec P-50S of a weighing capacity 64 g/m² was used, about 10% paper wrinkle was generated in the second image forming after an image was erased one time. Further, when the reversed crown quantity ΔD₅ was 100 μm, there was no paper wrinkle generated.

Further, when the reversed crown quantity ΔD₅ was 300 μm, no paper wrinkle was generated. However, in the image forming on unused paper, the rear edge portion of the unused paper leaped when passing through the nip of the fixing device and contact the entrance guide 26a of the fixing device and the image rubbing was caused at a rate of 3%. In addition, it was confirmed that the image rubbing increased remarkably when the reversed crown quantity ΔD₅ was made larger than 300 μm. From these results, the reversed crown quantity of the pressing rotary member is desirable at 100 to 300 μm.

As described above, according to the present invention, in the fixing device of a image forming apparatus using a toner that is erasable after fixed, the pressing rotary member is formed in the reversed crown shape and a recording medium is surely pulled to both edges and heated, pressed and fixed even when the pressing rotary member is in the life state. Accordingly, it is possible to prevent generation of paper wrinkles when fixing reuse paper and irrespective of use for an extended period, fixed images of high quality without paper wrinkles are obtained even on reuse paper.

1. A fixing device in an image forming apparatus comprising:
a fixing rotary member in contact with a toner image forming surface of he a recording medium; and
a pressing rotary member having a reversed crown shape in pressing contact with the fixing rotary member to convey the recording medium in a specified direction when fixing the toner image on the recording medium.

2. The fixing device as claimed in claim 1, wherein the surface hardness of the pressing rotary member is lower than that of the fixing rotary member.

3. The fixing device as claimed in claim 1, wherein a reversed crown quantity of the pressing rotary member is 100 to 300 μm.

4. The fixing device as claimed in claim 1, wherein the toner that is used in the image forming on the recording medium can be decolorized by a decolorizing apparatus.

5. The fixing device as claimed in claim 1, wherein the toner image on the recording medium is decolorized repeatedly by a decolorizing apparatus after the toner image was fixed.

6. A fixing device in an image forming apparatus, comprising:
a fixing roller in contact with a toner image forming surface of a recording medium on which image forming was processed at least two times; and
a pressing roller having a surface hardness being lower than that of the fixing roller and a reversed crown shape in pressing contact with the fixing roller to convey the recording medium in a specified direction when fixing the toner image on the recording medium.

7. The fixing device as claimed in claim 6, wherein a surface hardness of the pressing roller is lower than that of the fixing roller.

8. The fixing device as claimed in claim 6, wherein a reversed crown quantity of the pressing roller is 100 to 300 μm.

9. The fixing device as claimed in claim 6, wherein the toner image on the recording medium is decolorized repeatedly by a decolorizing apparatus after the toner image was fixed.

10. A fixing device in an image forming apparatus, comprising:
a fixing means in contact with a toner image forming surface on a recording medium on which image forming was processed at least two times; and
a pressing means having a reversed crown shape in pressing contact with the fixing means to convey the recording medium in a specified direction when fixing the toner image on the recording medium.

11. The fixing device as claimed in claim 10, wherein the surface hardness of the pressing means is lower than that of the fixing means.

12. The fixing device as claimed in claim 10, wherein a reversed crown quantity of the pressing means is 100 to 300 μm.

13. The fixing device as claimed in claim 10, wherein the toner that is used in the image forming on the recording medium can be decolorized by a decolorizing apparatus.

14. The fixing device as claimed in claim 10, wherein the toner image on the recording medium is decolorized repeatedly by a decolorizing apparatus after the toner image was fixed.

15. A fixing device in an image forming apparatus, comprising;
a fixing rotary member in contact with an image forming surface of a recording medium on which image forming was processed at least two times; and
a pressing rotary member having a reversed crown shape in pressing contact with the fixing rotary member to convey the recording medium in a specified direction when fixing the toner image on the recording medium.

16. The fixing device as claimed in claim 15, wherein the surface hardness of the pressing rotary member is lower than that of the fixing rotary member.

17. The fixing device as claimed in claim 15, wherein a reversed crown quantity of the pressing rotary member is 100 to 300 μm.

18. The fixing device as claimed in claim 15, wherein the image on the recording medium is decolorized repeatedly by a decolorizing apparatus after the toner image was fixed.

19. A fixing device in an image forming apparatus, comprising:
a fixing roller in contact with an image forming surface of a recording medium on which image forming was processed at least two times; and
a pressing roller having a reversed crown shape in pressing contact with the fixing roller to convey the recording medium in a specified direction when fixing the toner image on the recording medium.

20. The fixing device as claimed in claim 19, wherein a surface hardness of the pressing roller is lower than that of the fixing roller.

21. The fixing device as claimed in claim 19, wherein a reversed crown quantity of the pressing roller is 100 to 300 μm.

22. The fixing device as claimed in claim 19, wherein the image on the recording medium is decolorized repeatedly by a decolorizing apparatus after the toner image was fixed.

23. A fixing device in an image forming apparatus, comprising:
a fixing means in contact with the image forming surface of a recording medium on which image forming was processed at least two times; and
a pressing means having a reversed crown shape in pressing contact with the fixing means to convey the recording medium in a specified direction when fixing the toner image on the recording medium.

24. The fixing device as claimed in claim 23, wherein a surface hardness of the pressing means is lower than that of the fixing means.

25. The fixing device as claimed in claim 23, wherein a reversed crown quantity of the pressing means is 100 to 300 μm.

26. The fixing device as claimed in claim 23, wherein the image on the recording medium is decolorized repeatedly by a decolorizing apparatus after the image was fixed.
